(19) United States
(12) Patent Application Publication
(10) Pub. No.: US 2007/0188846 A1
(43) Pub. Date: Aug. 16, 2007

(54) MEMS switch with bistable element having straight beam components

(76) Inventors: James Melvin Slicker, West Bloomfield, MI (US); Ananthakrishnan Surianarayanan, Lansdale, PA (US); G K Ananthasuresh, Lansdale, PA (US)

Correspondence Address: RAM NATH, 2530 QUAIL RUN, LANSDALE, PA, 19446, US

(21) Appl. No.: 10/922,481

(22) Filed: Aug. 20, 2004

Related U.S. Application Data
(60) Provisional application No. 60/499,755, filed on Sep. 3, 2003.
(60) Provisional application No. 60/499,895, filed on Sep. 4, 2003.

(51) Int. Cl. G02B 26/00

(52) U.S. Cl. 359/290

(57) ABSTRACT

A MEMS switch of the type having a substrate and a bistable element, uses a structure for the bistable element having first and second substantially straight beam members that are bridged by an optional switch contact member. The switch contact member may be actuated to close a pair of fixed electrical contacts by an actuator means. The actuator means as described comprises electro-thermally compliant actuators. However, other types of actuators including thermo-pneumatic, thermal bimorphic, piezoelectric, electrostatic, fluidic, electromagnetic and phase change actuators may be used. The bistable element is structured to be moved between a first stable state and a second stable state by the selective urging action of two opposing actuators. The actuators, if the electo-thermal compliant type, may comprise first and second bound and spaced electrically conductive beams connected in parallel and supplied with an electrical current. The electrical current is shared by the two conductive beams unequally, causing a differential linear expansion in the two beams and consequential buckling. The buckling action of the bound and spaced beams is used to cause buckling movement of the bistable element from one stable state to the other. In a preferred embodiment, first and second support members, at least one of which is compliant, are interposed between the ends of the bistable element and the substrate. In an embodiment, an optional latch mechanism is used to initially make the bistable element go into one stable state. The latch mechanism may be operated by an auxiliary actuator.

### RELATED APPLICATIONS

This application is related to and claims priority from U.S. Provisional Application 60/499,755, filed on Sep. 4, 2003, and U.S. Provisional Application 60/499,895, filed on Sep. 4, 2003, both of which are incorporated herein by reference.

### FIELD OF THE INVENTION

This invention generally relates to Microelectro-mechanical System (MEMS) devices, and more particularly to MEMS devices with a bistable element having at least one straight beam component.

### BACKGROUND OF THE INVENTION

Microelectro-mechanical systems (MEMS) have recently been developed as alternatives for conventional electromechanical devices such as switches, actuators, valves and sensors. MEMS devices are potentially low cost devices, due to the use of microelectronic fabrication techniques. New functionality may also be provided because MEMS devices can be much smaller than conventional electromechanical devices.

U.S. Pat. No. 5,955,817 to Vijayakumar, et al. entitled “Thermal Arched Beam Microelectromechanical Valve” the disclosure of which is hereby incorporated by reference, discloses an arched beam, that, when heated by external electric heaters, expands to a greater arch to open a valve or perform some other desired actuation.

Many proposed applications of MEMS technology could utilize MEMS actuators. The Mechanical Transducers Sourcebook by G. T. A. Kovacs, McGraw-Hill 1998, refers to many actuator designs, utilizing thermopneumatic valve actuation, thermal bimorph actuation, piezoelectric actuation, electrostatic actuation, electromagnetic actuation, “phase-change” actuation and others.

German Patent Application (abandoned) publication DE-3833158A filed 1990, the disclosure of which is hereby incorporated by reference, discloses a bistable bending transducer with a piezoelectric strip-like bending element clamped under compressive forces at its longitudinally opposite edges by seating elements such that on bending, it assumes one of two stable positions defined by abutments, the seating elements being held by a holder and at least one of the seating elements being a compliant member. Electrical connections are provided for applying an actuating voltage on the piezoelectric bending element to displace the bending element into one or other of the two stable positions. In said German Patent Application, the compliant members are separate components from the bistable beam structure and thus some assembly is required. In addition, the German publication makes no reference to use as a MEMS device.

Alternatively, U.S. Pat. No. 6,303,885 B1 to Hichwa, et. al. entitled “Bi-Stable Switch” the disclosure of which is hereby incorporated by reference, discloses spring arms which act in conjunction with a hollow beam portion of a movable center body of the switch to accommodate strain in the spring arms as the switch is moved from a first position to a second position. The center body is moved in relation to static portions of the switch by an actuator. The Hichwa US patent differs from DE-3833158A in that its compliant member is replaced by compliant hollow beam portion of a movable center body, while the support elements are rigid. In addition, the structure in this US patent has an inherently unstable movement between the two stable states, requiring a double support structure to remedy the problem.

U.S. Pat. Application, Publication No. US 2003/0029705 A1 to Slocum, et.al, entitled “Bistable Actuation Techniques, Mechanisms, and Applications” the disclosure of which is hereby incorporated by reference, teaches a bistable MEMS structure having fixed end supports. The deflection element of this invention is supplied, as fabricated, curved in one of the two stable positions and in a mechanically unstressed condition along the length of the span. Also, the deflection element is constrained to substantially prohibit development of a second bending mode that is characteristic for the span as the element deflects between the two stable positions. Most importantly, the Slocum et al patent publication teaches a bistable MEMS structure having a curved member as fabricated, with fixed end supports.

Commercially available MEMS switches are electrostatically actuated and fall dramatically short of what is needed for RF power level. These electrostatically actuated RF MEMS switches are capable of only 0.1 Watts of transmitted power, while even the most meager requirements are for upwards of 2 Watts. Moulton and Ananthasuresh have reported in the publication “Micromechanical devices with embedded electro-thermal-compliant actuation” Elsevier, Sensors and Actuators, A 90 (2001) 38-48, the disclosure of which is hereby incorporated by reference, a means to achieve high actuation force using a folded beam structure, consisting of a narrow and wide beam attached to each other at both ends and connected electrically in parallel. An electrical current is made to pass through the parallel connection of beams, the electrical current being shared by the narrow and wide beams, more current flowing in the wide beam than the narrow beam. Consequently, because of differential expansion, the folded beam structure deflects toward the narrow beam. This action occurs because the wide beam by virtue of its having a lower resistance, draws more current and gets hotter than the narrow beam. As the expansion of the hotter wide beam is greater than that of the narrow beam, the folded beam structure will deflect towards the narrow beam. This arrangement has an advantage over the arched beam patent of Vijayakumar et al, referenced earlier, since no additional heating means is necessary. In addition, significantly, in the Elsevier, Sensors and Actuators publication, the electro-thermal actuation is capable of one hundred times the force of electrostatically actuated devices.

U.S. Patent application publication No. US 2003/0029705 A1 to Qiu, et. al. entitled,“Bistable Actuation Techniques, Mechanisms, and Applications” the disclosure of which is hereby incorporated by reference discloses a bistable MEMS structure having fixed end supports. The deflection element of this invention is supplied, as fabricated, curved in one of the two stable positions and in a mechanically unstressed condition along the length of the span. Also, the deflection element is constrained to substantially prohibit development of a second bending mode that is characteristic for the span as the element deflects between the two stable positions. Also, because of the design, the Qiu et al structure is not capable of applying force to sets of electrical contacts as desired. Thus, electrical contact is only provided in the second, “stressed” state and the switch is constrained to be a SPST.

Known MEMS switches use a bistable element that is curved as manufactured, using a process that is expensive and inconducive for economic mass production. It is desirable to provide a bistable MEMS switch including a structure that is not curved at the manufacturing stage and is consequently less expensive to manufacture. It is also desirable to provide a MEMS switch with a very effective actuating device and with a bistable element that has straight components as manufactured, the bistable element exhibiting stress in the in both its stable states whereby power is necessary only to alter the stable state of the MEMS switch from one of its stable states.

It is also desirable to provide a bistable MEMS switch that closes a set of contacts in both of its stable states, wherein power is necessary only to change between the two stable states. It is desirable to provide contact closures in both stable positions providing for a single pole double throw (SPDT) switch. To accomplish bipolar contact closures, it also is desirable to provide a bistable MEMS switch that exhibits stress in the bistable element only in both its stable states. It is also desirable to provide an improved structure for a bistable MEMS device that would be less expensive to produce. It also is desirable to provide an actuation means for the MEMS switch that exhibits high contact force upon closing.

### SUMMARY OF INVENTION

The present invention provides a bistable MEMS device, that comprises a bistable beam structure, herein also referred to as the bistable element, including first and second substantially straight members as manufactured. In a preferred form, the bistable element includes initially unstressed first and second straight members with an intermediate switch contact member bridging the first and second straight members of the bistable element. Preferably, the inventive MEMS device includes at least one support member that is anchored and formed preferably integrally with the bistable element, the support member initially being in an unstressed condition. The inventive MEMS device may have compliant first and second support members attached to a substrate and supporting the bistable element such that, with a sufficient force being applied at substantially the center of the bistable element, the bistable element will move between one of two stable states. An opposing force can move the bistable element back to its original stable state. As the bistable element moves between two stable states, the compliant support members might deflect away from the bistable element, allowing the bistable element to move back and forth. In one embodiment, the bistable element in the as-fabricated state is unstressed along the length of its structure and consists of three essentially first and second straight beam components and a bridging contact means, all forming a configuration geometrically biased toward the first stable state. When the bistable element is in the second stable state, the compliant support members resiliently flex to hold the beam structure in that state.

The bistable element needs two opposing forces to alternate between the stable states and these forces are preferably provided by Electro-thermally compliant (ETC) folded or parallel beam actuators similar to those reported by Moulton/Ananthasuresh, supra. Other arrangements for providing the requisite opposing forces are conceivable and are within the ambit of the present invention. Examples of such other arrangements include without limitation, actuator designs utilizing magnetic, electromagnetic, fluidic, thermo-pneumatic valve actuation, thermal bimorph actuation, piezoelectric actuation and electrostatic actuation.

The inventive MEMS device incorporates switching contacts that can be used for completing electrical switching which needs to be controlled. The configuration of the switching contacts is not critical to the present invention and can take one of several forms known in the art. Exemplary forms of the configuration of the switching contacts may be found in the publication “Low-Voltage Lateral-Contact Microrelays for RF Applications” Ye Wang, Zhihong L I, Danial T. McCormick and Norman C. Tien, Fifteenth IEEE International Conference on MEMS, Jan. 20, 2002 Las Vegas, which is incorporated herein by reference.

Preferred embodiments of the invention are described hereinafter. In one embodiment, the bistable element and the two ETC folded-beam actuators are fabricated as one piece of silicon attached to the compliant support members. In a second embodiment, the two ETC folded-beam actuators are attached to the substrate, while the bistable element is attached to the compliant support members.

According to a preferred embodiment of the present invention, the inventive bistable MEMS switch, also referred to herein as a MEMS actuator, includes (1) a microelectronic substrate, (2) first and second spaced apart mechanically compliant support members on the substrate, and (3) a bistable element comprising straight components, which may be in the form of a beam structure, extending between and integrally cooperating with the spaced apart support members. Preferably, two ETC actuators are provided for moving the compliant beam structure between the two stable states. The MEMS actuator of the present invention advantageously includes electrical contact switches for introducing electrical currents selectively through the two ETC actuators. As described hereinafter, the MEMS actuator in a preferred embodiment effectively converts the electrical current passing through the ETC actuators, into a deflection and a resultant force applied to the center of the bistable element or beam structure. Bi-directional movement of the bistable beam or element is achieved by selectively energizing either of the ETC actuators via electrical switching means associated with the ETC actuators.

In another aspect, the present invention teaches a microelectro-mechanical system (MEMS) switch with a bistable element and at least one actuator not requiring power consumption except when the actuator requires to be actuated. The invention in this embodiment teaches a MEMS switch of the type having a bistable element with first and second stable positions, wherein the bistable element has a first arm attached to a contact section (switch contact means) which is attached to a second arm. Both arms of the bistable element are essentially straight beams as manufactured, and attach to first and second support members that are fixed to a substrate. The MEMS switch may have first and second sets of electrical signal contacts. The switch contact means may be formed integrally with the bistable element, or, alternatively might comprise two switch contact members disposed at two ends of a rod member which penetrates and is rigidly joined to the bistable element. The first and second arms of the bistable element are compliant and are initially unstressed and substantially straight as manufactured. At least one said support member is compliant and cooperates with a latch. In a preferred embodiment, an auxiliary MEMS actuator is employed to operate the latch to act upon the compliant support member to push it in the direction of the second support member so as to enable the bistable element to go into its first stable position and close the first set of electrical signal contacts. Advantageously, the latch is configured to be locked in position so that the bistable element remains in its first stable position even with the auxiliary MEMS actuator turned off. The main actuator enables the bistable element to take one of the two stable positions. A second main actuator may be used in conjunction with the first one to enable the bistable element selectively to go into either the first or the second stable position.

In a variation of the invention, the first set of electrical signal contacts is mounted on resilient supports which are actuated by the auxiliary MEMS actuator, without the need for the latch. Even in this variation of the invention, first and second actuators enable the bistable element to selectively go into first and second stable positions without any need for power consumption for the bistable element to continue to stay in the first or second stable positions.

### BRIEF DESCRIPTION OF THE DRAWINGS

A more detailed understanding of the invention may be had from the following description of preferred embodiments, given by way of example and to be understood in conjunction with the accompanying drawing wherein:

FIG. 1 shows one embodiment of the MEMS switch of the present invention in the first of two stable positions;

Fig.2 shows the MEMS switch of FIG. 1 at the start of switching between states;

FIG. 3 shows the MEMS switch of FIG. 1 when the bistable element or beam is just past the midpoint of its travel between two states;

FIG. 4 shows the MEMS switch of FIG. 1 in the second stable position;

FIG. 5 shows a second embodiment of the MEMS switch of the present invention in the first of two stable positions;

FIG. 6 shows the MEMS switch of FIG. 5 in the act of switching between the two states, and,

FIG. 7 shows the MEMS switch of FIG. 5 in the second stable state.

FIG. 8 shows one embodiment of the bistable MEMS switch of the present invention in the unstressed pre-fabrication stage.

FIG. 9 shows the MEMS relay of FIG. 8 after the auxiliary actuator has been activated.

FIG. 10 shows the MEMS bistable mechanism of Qiu et. al. in the as-fabricated position.

FIG. 11 shows the MEMS bistable mechanism of Qiu et. al. stressed positions using the auxiliary actuator of this invention.

FIG. 12 shows one embodiment of the latching mechanism.

FIG. 13 shows the embodiment of the latching mechanism of FIG. 12 after insertion.

FIG. 14 shows a second embodiment of the SPDT switch in the unstressed pre-fabrication stage,

FIG. 15 shows the MEMS switch of FIG. 14 after the auxiliary actuator has been activated.

### DETAILED DESCRIPTION OF THE EMBODIMENTS

The present invention now will be described hereinafter with reference to the accompanying drawings, in which preferred embodiments of the invention are shown. This invention may, however, be embodied in many different forms and should not be construed as limited to the embodiments set forth herein; rather, these embodiments are provided so that this disclosure will be thorough and complete, and will fully convey the scope of the invention to those skilled in the art. Like numerals refer to like elements throughout. Note the drawing figures are not to scale and the relative dimensions of each of the elements must be selected to give the desired motion.

Bi-stable Operation

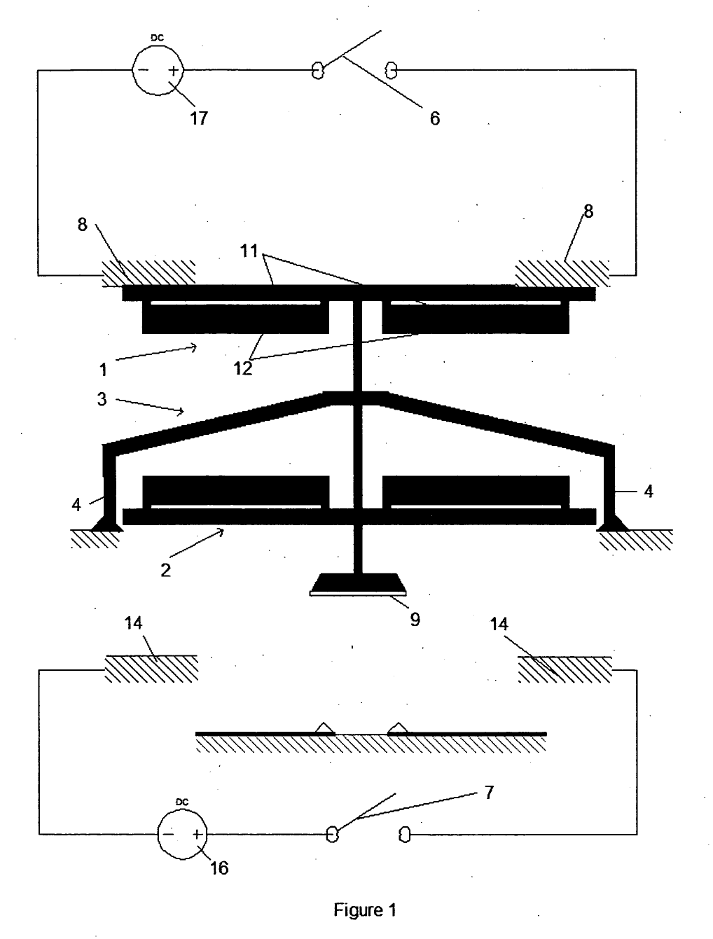

Bi-stable operation is achieved by providing stable states of the compliant beam structure of the bistable element at both extreme ends of the travel. FIG. 1 shows one stable state for the structure when the actuator is in the “up” or “as fabricated” position. For simplicity of the description, “up” refers to the top of the drawing and “down” refers to the bottom of the drawing. Recall that the motion of the actuator is in the plane of the substrate and no “up” or “down” motion exists with reference to the substrate. In one embodiment, the beam structure, as-fabricated, is initially unstressed along its length while in the up position. Without any external force; the beam structure will remain in the as-fabricated state because any deflection of the beam structure from this state would require moving the structure to a higher energy level, and thus the structure will remain in the first stable state unless external forces are applied.

This structure is forced from the up state to the down state by electrically energizing the top ETC actuator thereby applying a force to the bistable element, forcing it to move downward. This action will cause the first and second compliant support beams to spread apart enough to enable the bistable beam structure to bend down to the “down” stable state. After reaching the “down” state, the electric current is switched off, conserving energy. In the “down” state, the compliant support beams are restored and move back towards each other without spreading, to hold the bistable beam structure in the down position.

According to one embodiment, as shown in FIGS. 1-4 of the drawings, a conducting path for the electrical signal is provided when the bistable element is in the down state. A number of MEMS devices have also been envisioned according to the present invention that utilize one or more MEMS actuators acting in parallel for providing large forces and displacements while consuming minimal amounts of power. Means of fabricating the actuator of this invention are well known in the art. For example, the device may be fabricated according to facilities of Sandia National Laboratories in New Mexico using a multi-layer process, which is capable of fabricating this device. As aforesaid, other means of causing the deflection in the bistable element or member between its first and second stable states are possible and are within the ambit of this invention.

Some detail for processes to make various embodiments of integrated valve structures is known as exemplified by U.S. Pat. No. 5,955,817 to Vijayakumar, et al., U.S. Pat. Nos. 4,821,997, 4,824,073, 4,943,032 and 4,966,646, 6,303,885 B1 to Hichwa, et. al., and the Moulton, Ananthasuresh paper, all of which are hereby incorporated by reference herein.

FIGS. the 1-4 show a first embodiment of the switch at four stages of switching from one stable state to the alternate stable state. Referring to FIG. 1, the switch starts out in stable state 1. The switch contact means 9 cooperating with the bistable element 3 closes signal contacts 10 in the UP position. The MEMS switch structure as shown consists of ETC actuators 1 and 2 and bistable element 3 which is attached to the substrate through compliant supports 4. Compliant supports 4 also keep the bistable element 3 in the “up” position when electrical switches 6 and 7 are open. The bistable element remains in the up position when no force is applied to it because the element is unstressed along its length, and movement downward requires the bistable element 3 to be urged to move to an increased energy level. ETC actuator 1 rests against fixed supports 8. Fixed supports 8 also-are connected to voltage source 17 via switch 6.

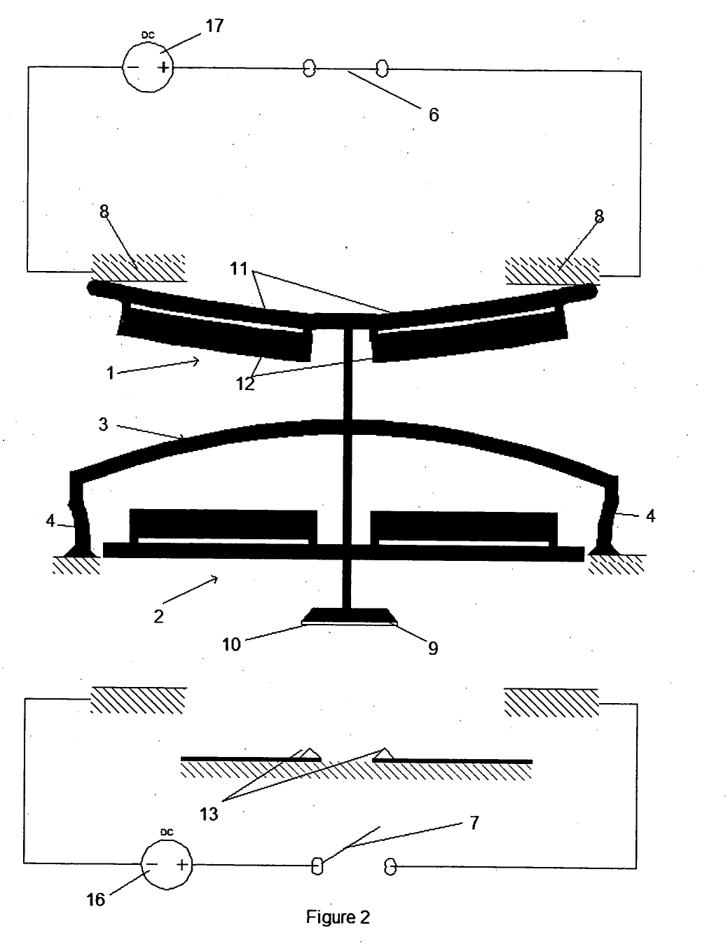

Referring to FIG. 2, the start of actuation occurs with the closure of switch 6, which injects a current into ETC structure 1, causing it to deflect the bistable element 3 toward the second stable state. The actuation of ETC structure 1 occurs, because most of the electric current goes through the thick beam 12 causing the thick beam to get hotter than the thin beam 11. The thick beam 12 gets hotter because it has a lower electrical resistance than the thin beam and, thus, carries more current. The hotter thick beam thermally expands more than the relatively cooler thin beam, causing the ETC structure to bend toward the cooler thin beam, bending the bistable element toward the second stable state.

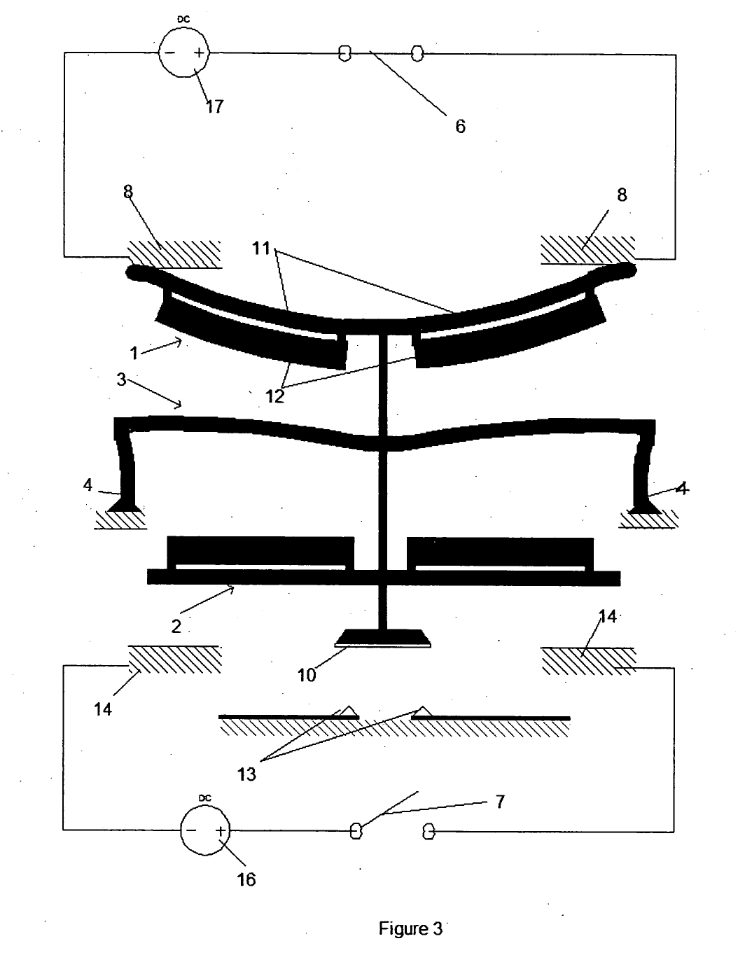

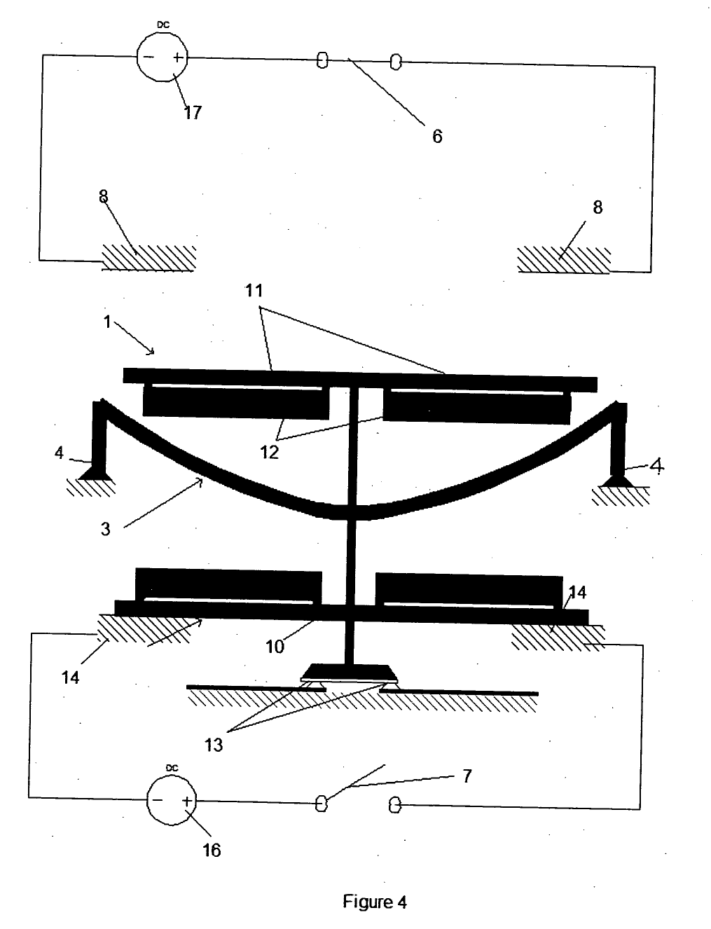

Referring to FIG. 3, the actuation process shown in FIG. 2 continues to the point where the bistable element 3 is bent just past the midpoint between the two stable states. At this point the bistable element 3 will “snap” toward the second stable state as shown in FIG. 4. When the bistable element switch structure is in the second stable state, the switch contact means 9 shorts signal contacts 13. In the second stable state, ETC member 1 will be released from fixed supports 8 and its associated electrical contacts. ETC member 2 will be in contact with fixed supports 14. Thus the bistable element switch structure can be moved back to stable state 1 by closing switch 7, which reverses the process.

Making electrical contact via in-plane motion of the actuator requires that the contact portion of the bistable element and the contacts mounted on the substrate be equipped with lateral contacts. An exemplary method of fabricating lateral contacts on a MEMS switch that uses in-plane motion is described in Wang, et al “Low-Voltage Lateral-Contact Microrelays for RF Applications” presented at MEMS 2002 Fifteenth IEEE International Conference on MEMS, Las Vegas, Nev., Jan. 20-24, 2002. The MEMS switch in the Wang et al reference uses silicon nitride as the structural material and sputtered gold as the contact material. Other methods of fabricating MEMS switch contacts are equally applicable for use in the present invention.

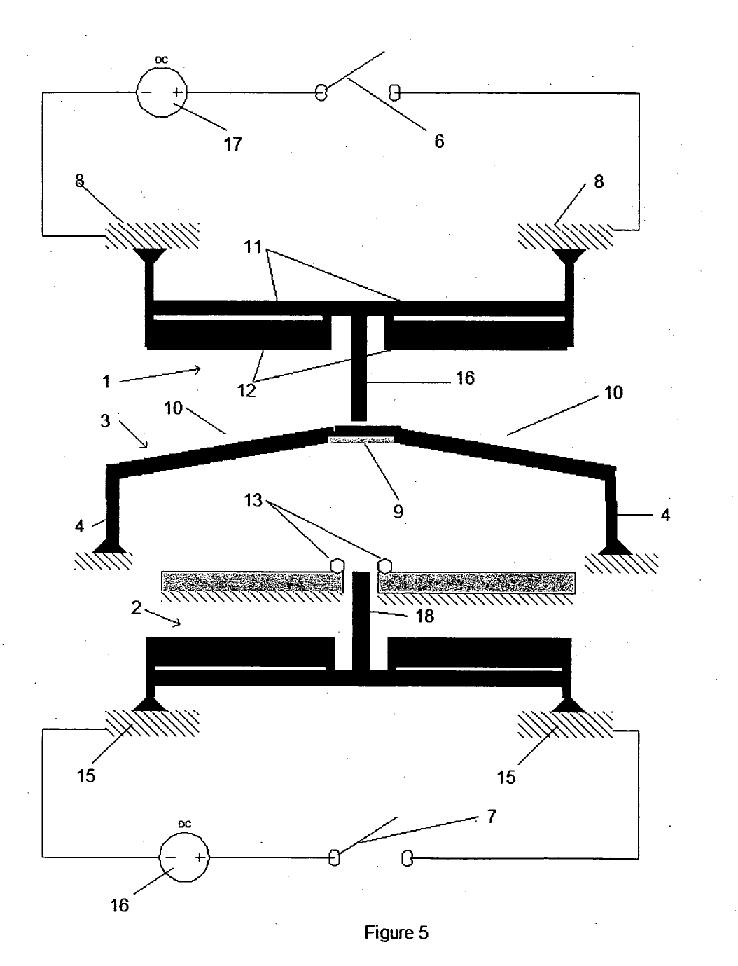

FIGS. the 5-7 show a second embodiment of the switch at three stages of switching from one stable state to the second stable state. Referring to FIG. 5, the switch starts out in stable state 1. The switch consists of ETC actuators 1 and 2 and bistable element 3. The bistable element 3 is attached to the substrate through compliant supports 4. Compliant supports 4 also keep the bistable structure 3 in the “up” position when electrical switches 6 and 7 are open. ETC actuator 1 is attached to the substrate by fixed supports 8. ETC actuator 1 also is connected to voltage source 17 via switch 6. ETC actuator 2 is attached to the substrate by fixed supports 14. ETC actuator 2 also is connected to voltage source 16 via switch 7. When the switch structure is in the first stable state, switch contact means 9 shorts signal contacts 10. When the switch structure is in the second stable state, switch contact means 9 shorts signal contacts 13.

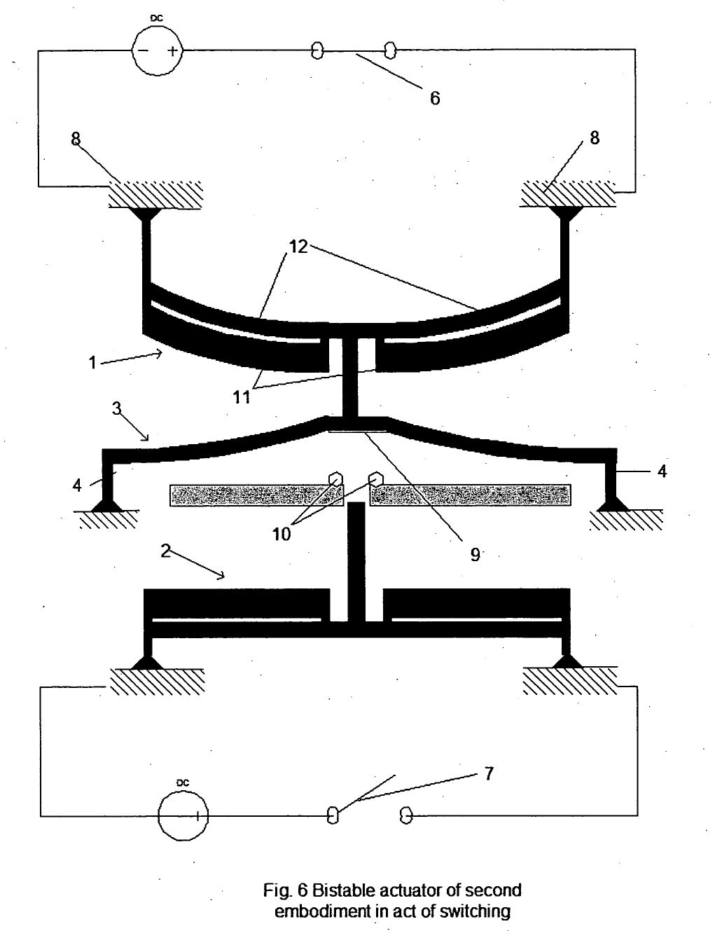

Referring to FIG. 6, the start of actuation occurs with the closure of switch 6, which injects a current into ETC structure 1, causing it to bend the bistable structure toward the second stable state. The bending of ETC structure 1 occurs, because most of the electric current goes through the thick beam 11 causing the thick beam to get hotter than the thin beam 12. The thick beam 11 gets hotter because it has a lower electrical resistance than the thin beam and, thus, carries more current. The hotter thick beam thermally expands more than the relatively cooler thin beam, causing the ETC structure 1 to bend toward the cooler thin beam. This bending of ETC actuator 1 results in a force on the bistable element 3 through member 16 pushing the bistable structure 3 toward the second stable state.

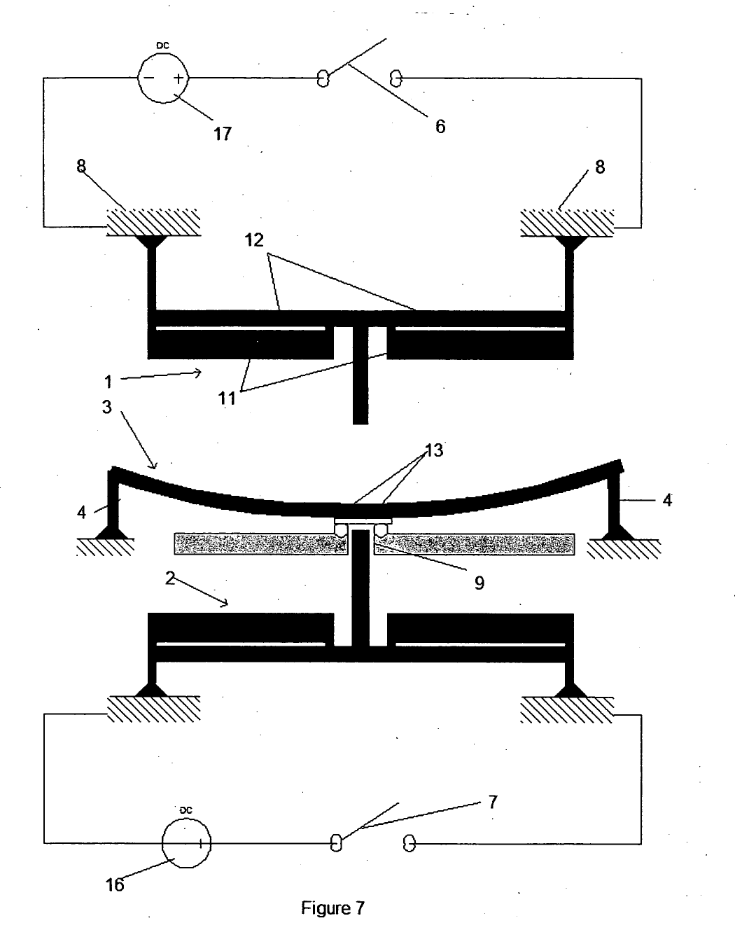

Referring to FIG. 7, the actuation process continues to the point where the bistable structure will “snap” toward the second stable state. When the switch structure is in the second stable state, switching contact means 9 shorts signal contacts 13. The switch structure can be moved back to stable state 1 by closing switch 7, which reverses the process.

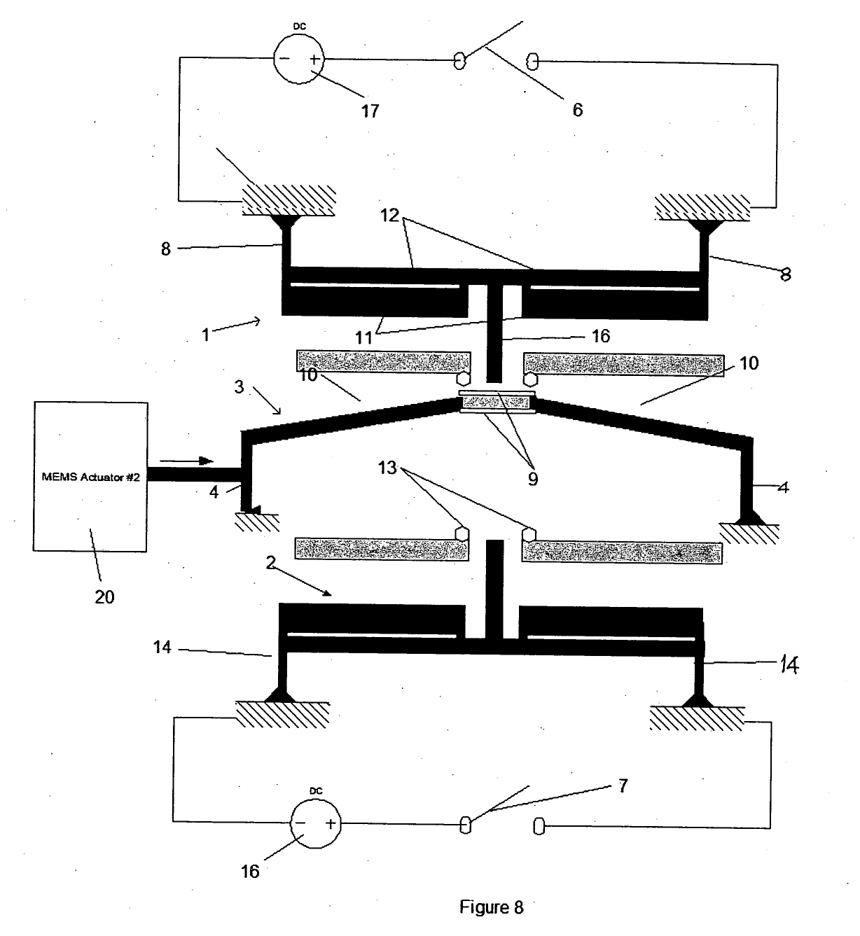

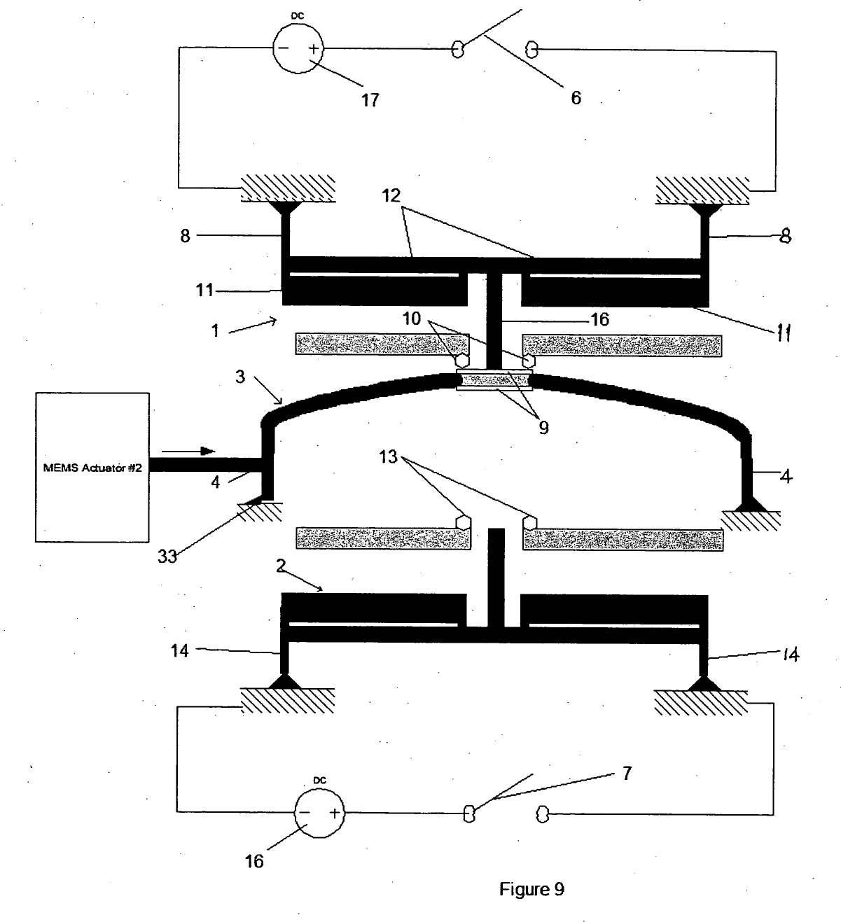

FIGS. 8 and 9 show another embodiment of the switch in the as-fabricated unstressed condition and in the full contact, stressed condition respectively. This embodiment can be configured for SPDT operation. Referring to FIG. 8, the switch structure includes ETC actuators 1 and 2 and bistable element 3. ETC actuators 1 and 2 are attached to substrate 8. The bistable element or structure 3 is attached to the substrate through compliant supports 4. Initially, bistable element 3 is unstressed, and support 4 may be unattached from substrate 8, and switch contact element 9 is not in contact with electrical contacts 10. Referring to FIG. 9, auxiliary MEMS actuator 20 is activated, which pushes left support 4 towards and in the direction of the other support 4, causing switch contact element 9 to move up and engage electrical contacts 10 and imparting a stress on bistable element 3. When in this position, referred to as stable position 1, compliant supports 4 keep the bistable element 3 in this position when electrical switch 6 is open. Activation of auxiliary actuator 20 pushes support 4 inward, causing the left support 4 to be held in place by latch mechanism 33 so that auxiliary actuator 20 does not need to remain activated. Actuator 1 also is connected to voltage source 17 via switch 6. Note that the drawings or figures are not to scale and the relative dimensions of each of the elements must be selected to give the desired motion. Actuation of the switch illustrated in FIGS. 8 and 9 is performed as follows. Referring to FIG. 9, the switch starts out in stable state 1. The switch includes ETC actuators 1 and 2 and bistable element 3. The bistable element is attached to the substrate through compliant supports 4. ETC actuator 2 also is attached to the substrate 8 and connected to voltage source 16 via switch 7. When the switch structure is in the first stable state, switch contact element 9 shorts signal contacts 10. When the switch structure is in the second stable state, switch contact element 9 shorts signal contacts 13.

The start of actuation occurs with the closure of switch 6, which injects a current into ETC actuator 1, causing it to urge the bistable element toward the second stable state. This action of the of ETC actuator 1 occurs because most of the electric current goes through the thick beam 11 which has a lower electrical resistance, causing the thick beam 11 to get hotter than the thin beam 12. The hotter thick beam 11 thermally expands more than the relatively cooler thin beam 12, causing the ETC actuator 1 to buckle towards the cooler thin beam 12. This action of ETC actuator 1 results in a force on the bistable element 3 through member 16 pushing the bistable element or structure 3 toward the second stable state.

When the MEMS switch is in the second stable state, switch contact element 9 shorts signal contacts 13. The MEMS switch structure can be moved back to stable state 1 by closing switch 7 of actuator 2, which reverses the process. As aforesaid, the actuators 1 and 2 as illustrated are ETC actuators; however, the actuators 1 and 2 can be other types including thermo-pneumatic, thermal bimorphic, piezoelectric, electrostatic, electromagnetic and phase change actuators.

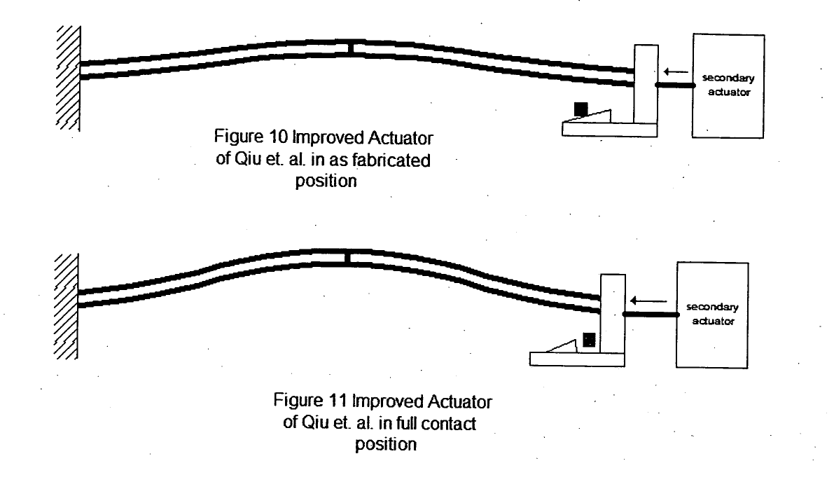

FIG. 10 and FIG. 11 show an embodiment of the invention which converts the single pole single throw (SPST) switch of Qiu et. al. into a single pole double throw (SPDT) type by the application of the secondary MEMS actuator which pushes an un-anchored support member of the bistable element horizontally such that the bistable element arches higher. Provision of a set of electrical contacts as in FIGS. 8 and 9 would provide a switch closure while the bistable element is in the first stable state. The bistable element could advantageously be fabricated to comprise first and second substantially straight members and a bridging contact member. By a suitable modification using the principles of the present invention and the latch mechanism, the embodiment of FIGS. 10 and 11 might be altered to provide a single pole double throw, or a double pole double throw (DPDT) switch.

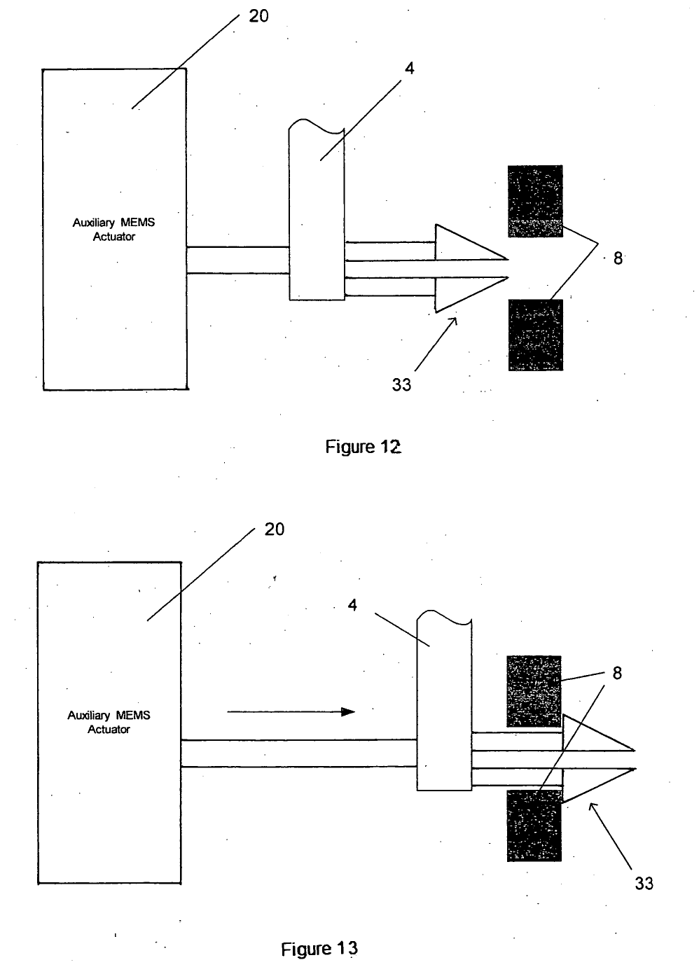

The exact structure of latching device 33 is not critical to this invention, since numerous latching devices have been developed over many years and several of these devices would be suitable for this task. However, for the purpose of illustration, one embodiment of a latching device suitable for this application is shown in FIGS. 12 and 13. FIG. 12 shows the latching device 33 in its original position, before activation of auxiliary MEMS Actuator 20. FIG. 13 shows the latching device 33 after auxiliary MEMS Actuator 20 has been activated. Also shown in FIGS. 12 and 13 are compliant support member 4 and substrate 8. If necessary, once support member 4 is fixed or anchored by latching device 33 into substrate 8, the latching mechanism 33 can be bonded to substrate 8 by a suitable bonding process, there being several bonding processes known in the art. For example, a process known as “fusion bonding” would be suitable. Other bonding processes are equally applicable.

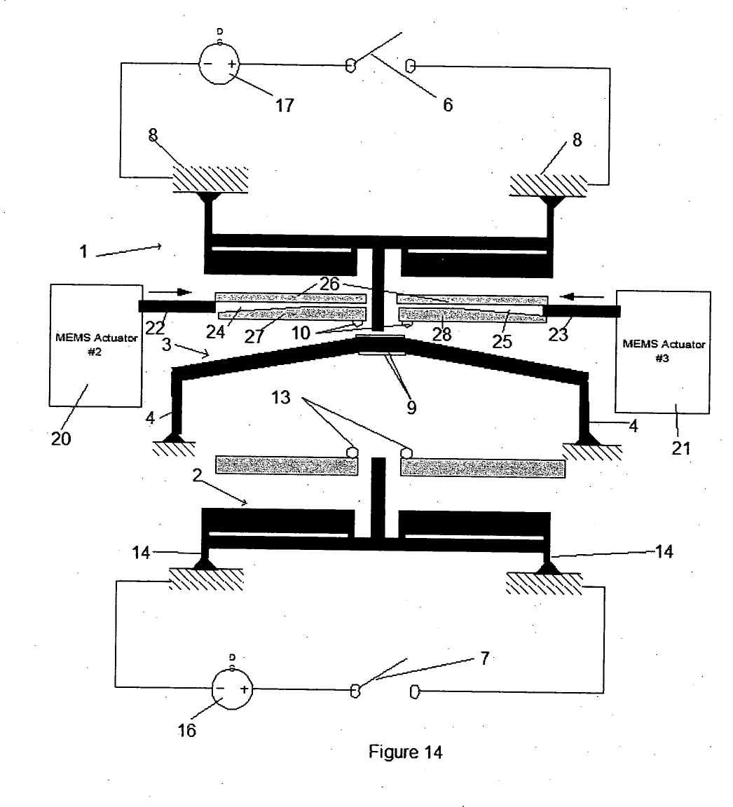

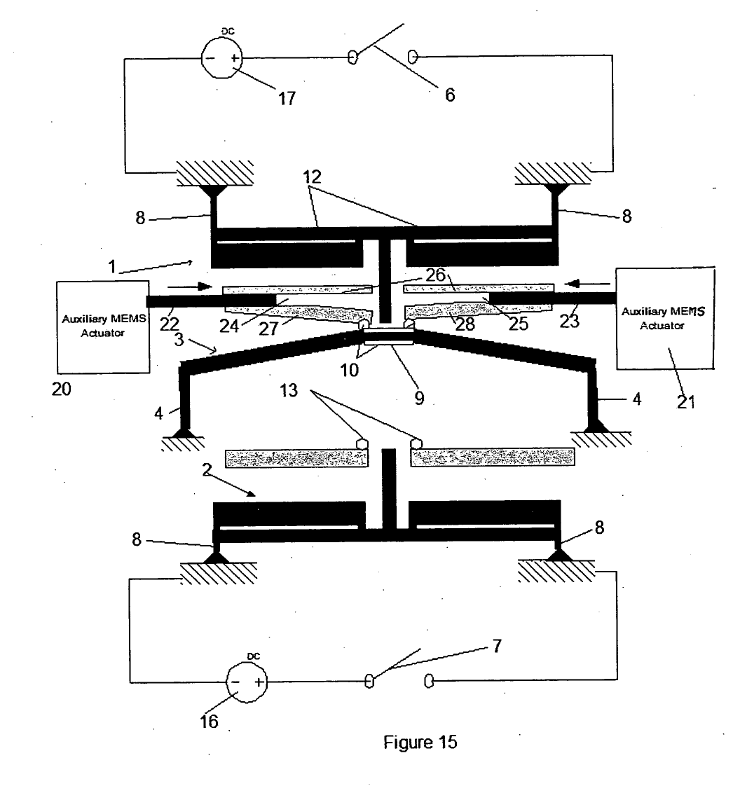

Another embodiment of a SPDT switch is shown in FIG. 14 and FIG. 15. The bistable element may advantageously fabricated using two substantially straight members and a bridging contact member 9 as in the previous embodiments. In this embodiment, instead of the auxiliary MEMS actuator applying stress on the bistable element 3 through support 4, two MEMS auxiliary actuators move electrical signal contacts 10 into electrical contact with switch contact element 9. Auxiliary MEMS actuators 20 and 21 insert beam elements 22 and 23 into grooves 24 and 25. As illustrated, grooves 24 and 25 are formed between rigid member 26, which is wholly bonded to the substrate, and compliant members 27 and 28 that are resiliently bonded to the substrate for only a portion of their lengths. Thus, when auxiliary actuators 20 and 21 are activated, compliant members 27 and 28 are forced to move electrical signal contacts 10 into contact with switch contact element or member 9. The final position after activation of auxiliary MEMS actuators 20 and 21 is shown in FIG. 15. Actuator beam elements 22 and 23 are preferably equipped with latching elements (not shown) as in FIGS. 12 and 13 to hold and retain them in the inserted position so that the electrical signal contacts 10 remain closed.

The foregoing description of preferred embodiments of the invention teaches structure and the manner of operation of examples of the MEMS switch constructed using the principles of the invention. A MEMS switch with a bistable element using first and second substantially straight beams or elements and an intermediate contact member is less expensive to manufacture than a switch with a prior art type bistable element having a curvilinear configuration. The use of the latch mechanism in conjunction with the bistable element of the present invention offers commercial advantages of economy and simplicity to MEMS switches thereby making it conducive for their mass production. Variations in the structure and geometry of the components and modifications in the materials are conceivable and are within the ambit of the invention as defined by the appended claims.

What is claimed is:

1. A micro-electromechanical system (MEMS) switch of the type that uses a substrate and a bistable element having first and second stable positions, said MEMS switch having a bistable element including substantially straight first and second beam members as fabricated, and
actuator means to urge said bistable element selectively into said first and second stable positions.

2. The MEMS switch of claim 1, wherein said first and second beam members are in an unstressed condition as manufactured, said MEMS switch including a switch contact means disposed bridging said first and second beam members and forming part of said bistable element, said MEMS switch including first and second sets of electrical signal contacts which are mounted so as to be selectively closed by said switch contact means of said bistable element.

3. The MEMS switch of claim 2, wherein said first set of electrical signal contacts is mounted on said substrate to be resiliently movable to engage said switch contact means of said bistable element, wherein said actuator means is configured for consuming power only to urge said bistable element into its first and second positions but not for maintaining the bistable element in said first and second stable contact positions.

4. The MEMS switch of claim 3, including an auxiliary actuator disposed to cause said first and second sets of electrical contacts selectively to resiliently move to electrically engage said switch contact means of said bistable element.

5. The MEMS switch of claim 2, including a first substantially straight support member formed integrally with said bistable element, the MEMS switch further including a second substantially straight support member mounted on said substrate and disposed away from said first support member and formed integrally with said bistable element, said second support member being in an unstressed condition as manufactured, wherein said first and second support members are compliant and cooperate with said bistable element to enable the bistable element to go into said first and second stable positions.

6. The MEMS switch of claim 5 wherein said actuator means comprises first and second electro- thermally compliant (ETC) actuators for urging said bistable element selectively between said first and second stable positions.

7. The MEMS switch of claim 6 wherein said ETC actuators comprise electrical actuators each including an on/off switch.

8. The MEMS switch of claim 7 wherein each said ETC actuator comprises a current carrying composite beam, having a first wider beam spaced and connected electrically in parallel with a second narrower beam.

9. The MEMS switch of claim 1, wherein said actuator means includes first and second actuators chosen from a group of actuators comprising: thermo-pneumatic, thermal bimorphic, piezoelectric, electrostatic, fluidic, electromagnetic, electro-thermally compliant and phase change actuators.

10. The MEMS switch of claim 8 wherein each said ETC actuator includes a rod member which in cooperation with said actuator means, can move axially, for selectively urging said bistable element between said first and second stable positions.

11. The MEMS switch of claim 10 wherein said rod member of each said ETC actuator is axially connected to said bistable element, and wherein said switch contact means of the bistable element includes first and second switch contact members rigidly attached to said rod member.

12. The MEMS switch of claim 5 including an auxiliary MEMS actuator and a latching element that is operable by said auxiliary MEMS actuator to go into an engaged position to push said at least one support member into a compliant position from its initial unstressed condition.

13. The MEMS switch of claim 12 wherein said latching element is configured to hold said at least one support member in said compliant position to assist movement of said bistable element.

14. The MEMS switch of claim 12 wherein said latching element is configured to be selectively to locked to stay in its engaged position even with said auxiliary MEMS actuator turned off.

15. The MEMS switch of claim 12 wherein said first and second pairs of signal contacts are disposed on opposite sides of said bistable element, wherein said first and second support members together by virtue of their compliant structure enable said bistable element to selectively go into its said first and second stable positions upon being urged by said actuator means.

16. The MEMS switch of claim 1 including first and second pairs of signal contacts disposed on opposite sides of said bistable element, said MEMS switch including first and second substantially straight compliant support members disposed away from each other on said substrate and formed integrally with said bistable element, said MEMS switch including an auxiliary actuator that may be actuated to urge said first pair of signal contacts into electrical contact with a switch contact means disposed on said bistable element.

17. The MEMS switch of claim 16 wherein said actuator means comprises first and second electro-thermally compliant (ETC) actuators, said first actuator being capable of urging said bistable element to go into its stable state and close said second pair of signal contacts via said switch contact means of said bistable element.

18. The MEMS switch of claim 17 wherein said first and second ETC actuators are mounted on said substrate.

19. The MEMS switch of claim 6 wherein said first and second ETC actuators are mounted on said substrate.

20. The MEMS switch of claim 17, wherein said first and second ETC actuators each includes a power source, a switch and a composite conductive beam structure having first and second spaced apart beams electrically connected in parallel, the first spaced apart beam having a relatively larger cross sectional area than the second spaced apart beam.

21. A microelectromechanical (MEM) device comprising:
a substrate;
a stationary signal contact pair formed on said substrate;
a bistable element capable of first and second stable positions and mounted on said substrate, said bistable element including first and second substantially straight members that are unstressed as manufactured, said first and second straight members being connected to a bridging switch contact means, said switch contact means being configured to selectively close said stationary signal contact pair,
a first microelectronic actuator disposed to act on said bistable element to urge said bistable element from said first stable position to a second stable position to move said switch contact means to make electrical contact with said stationary signal contact pair; and
a second microelectronic actuator acting on said bistable element in an opposing direction to said first microelectronic actuator to force said bistable element from its second stable position back to its first stable position.

22. The microelectromechanical device of claim 21 including a second signal contact pair disposed on a side opposite of said bistable element relative to said first signal contact pair, wherein said first microelectronic actuator is an electrical thermally complaint device.

23. The microelectromechanical device of claim 21, wherein said second microelectronic actuator is an electrical thermally complaint device.

24. The microelectromechanical device of claim 21, wherein said first and second substantially straight members of the bistable element together with the switch contact means act as a flexible beam having a first end attached to said substrate and an opposite second end attached to said substrate.

25. The microelectromechanical device of claim 24, further comprising a first support member interposed between said first end of said bistable element and said substrate and a second support member interposed between said second end of said bistable element and said substrate.

26. The microelectromechanical device of claim 25, wherein at least one of said first and second support members bends as said bistable element transitions between said first stable state and said second stable state.

27. The microelectromechanical device of claim 22, wherein said first microelctronic actuator is attached to said substrate.

28. The microelectromechanical device of claim 23, wherein said second microelectonic actuator is attached to said substrate.

29. The microelectromechanical device of claim 21, wherein said first and second support members are rigidly supported by said substrate on opposite ends of said bistable element.

30. The microelectromechanical device of claim 21, further comprising a first switchable electrical power source electrically connected to said first microelectronic actuator and a second switchable electrical power source electrically connected to said second microelectronic actuator.

31. A bistable electromechanical device comprising:
a substrate;
a first micro actuator supported to said substrate;
a second micro actuator supported to said substrate and positioned to act in an opposing direction to said first micro actuator;
a set of electrical contacts attached to said substrate;
a bistable element attached to said substrate and comprising first and second substantially straight beam elements and positioned between said first micro actuator and said second micro actuator, said bistable element having a first stable state and a second stable state;
a switch contact element extending through and attached to said first micro actuator, said second micro actuator and said bistable element, said switch contact element having a first contactor formed at one end and a second contactor formed at a second end;
wherein said switch contact element electrically and selectively closes said set of contacts when said bistable element is in said second stable state.

32. The microelectromechanical device of claim 31, wherein said first micro actuator comprises an electrothermally compliant (ETC) device.

33. The microelectromechanical device of claim 31, wherein said second micro actuator comprises an electrothermally compliant device.

34. The microelectromechanical device of claim 31, wherein said bistable element functions as a flexible beam having a first end attached to said substrate and an opposite second end attached to said substrate.

35. The microelectromechanical device of claim 31, further comprising a first support arm member interposed between said first end of said bistable element and said substrate, and a second support arm member interposed between said second end of said bistable element and said substrate.

36. The microelectromechanical device of claim 35, wherein said first and second support arm members selectively flex when said bistable element transitions between said first stable state and said second stable state.

37. The microelectromechanical device of claim 31, wherein first and second support arm members are relatively unstressed when said bistable element is in first stable position.

38. The microelectromechanical device of claim 31, wherein said first and second micro actuators are positioned on opposite sides of said bistable element.

39. The microelectromechanical device of claim 31, further comprising a first switchable electric power source electrically connected to said first microelectronic actuator.

40. The microelectromechanical device of claim 31, further comprising a second switchable electric power source electrically connected to said second micro actuator.

41. A bistable microelectromechanical device comprising:
a substrate;
a stationary signal contact pair mounted to said substrate;
an auxiliary actuator means attached to said substrate;
a bistable element having first and second stable operating positions and having a first end attached to said auxiliary actuator and a second end attached to said substrate, said bistable element being configured, after fabrication, to be urged into its first stable operating position;
an actuator acting on said bistable element to force said bistable element from a first stable operating position to a second stable operating position, said bistable element bridging said stationary signal contact pair when said bistable element is in said second stable operating position.

42. The microelectromechanical device of claim 41 wherein said bistable element is comprised of a first arm attached to a second arm with a switch contact section disposed there between, said first and second arms being substantially straight and unstressed as manufactured, until said auxiliary actuator means acts to force said bistable element into a first or second operating position.

43. The microelectromechanical device of claim 42 wherein said actuator means is comprised of at least one electro-thermally compliant device.

44. The microelectromechanical device of claim 41 wherein said auxiliary accelerator means operates a latch to urge said bistable element into its said first operating position.

45. The microelectromechanical device of claim 41 further comprising a latching device mounted to said substrate and to said bistable element for retaining said bistable element in a first or second operating position after said auxiliary actuator forces said bistable element into said first operating position.

46. The microelectromechanical device of claim 42 further comprising a second stationary signal contact pair positioned opposite said first stationary signal contact pair, wherein said second stationary contact pair is electrically closed by said switch contact section of the bistable element when said bistable element is in said first operating position.

47. The microelectromechanical device of claim 44 further comprising a second electrothermally compliant actuator actuating said bistable element when in its second stable operating position to bring said bistable element back to its first stable operating position.

48. A bistable microelectromechanical device comprising:
a substrate
a flexible signal contact pair mounted to said substrate;
a bistable element having first and second stable operating positions and attached to said substrate, said bistable element including a first arm attached to a switch contact section which is attached to a second arm, said first and second arms, as manufactured being relatively straight and unstressed along their respective lengths when said bistable element is in a first bistable position;
an auxiliary actuator means attached to said substrate and acting on said flexible contact pair wherein following fabrication of said bistable element and said flexible contact pair, said auxiliary actuator means is energized to urge said flexible contact pair into contact with said switch contact section of said bistable element; and,
an actuator contacting said bistable element to force said bistable element from its first stable operating position to its second stable operating position.

49. The microelectromechanical device of claim 48 further comprising a latching device mounted to said substrate and cooperating with said auxiliary actuator to move said flexible signal contact pair to retain contact with said contact element when said bistable element is in said first stable operating position.

50. A microelectromechanical device comprising;
a substrate;
a primary actuator attached to said substrate;
an auxiliary actuator attached to said substrate, wherein said auxiliary actuator acts to adjust or otherwise modify said primary actuator during assembly.

51. The microelectromechanical device of claim 50 further comprising a latching device mounted to said substrate and to said auxiliary actuator for retaining said auxiliary actuator in said modified state.

52. A micro-electromechanical system (MEMS) switch of the type that uses a substrate and a bistable element having first and second stable positions, said MEMS switch comprising:
a bistable element including substantially straight first and second beam members that are unstressed as manufactured;
a pair of fixed electrical contacts mounted to said substrate;
actuator means to urge said bistable element selectively into a second stable position from a first stable position, said actuator means being configured to close said pair of fixed electrical contacts in the second stable position of the bistable element.

53. The MEMS switch as in claim 52, wherein said actuator means comprises first and second electro-thermally compliant (ETC) actuators, each having a power supply and a switch.

54. The MEMS switch as in claim 53, wherein each said ETC actuator includes a composite beam structure with a first narrow and a relatively wider second current carrying beam member.
